(19) United States
(12) Patent Application Publication
(10) Pub. No.: US 2018/0286062 A1
(43) Pub. Date: Oct. 4, 2018

(54) INFORMATION PROCESSING DEVICE, INFORMATION PROCESSING METHOD, PROGRAM, AND IMAGE CAPTURING DEVICE

(71) Applicant: SONY CORPORATION, TOKYO (JP)

(72) Inventor: EIJI YAMAMOTO, SAITAMA (JP)

(21) Appl. No.: 15/544,662

(22) PCT Filed: Nov. 27, 2015
(86) PCT No.: PCT/JP2015/083424

§ 371 Date: Jul. 19, 2017

(30) Foreign Application Priority Data
Feb. 4, 2015 (JP) 2015-020094

(51) Int. Cl. G06T 7/521; G06T 7/40; G06T 7/529; G06T 7/593

(52) U.S. Cl. CPC G06T 7/521; G06T 7/40; G06T 7/529; G06T 2207/10012; G06T 2207/10028; G06T 2207/30196; G06T 7/593

(57) ABSTRACT

An area determination unit 31 determines an active-method application area in which three-dimensional information is acquired on the basis of reflected light of a projected predetermined luminous flux and a passive-method application area that is another area and outputs an area determination result RD to a three-dimensional information acquisition unit 41. On the basis of the area determination result RD, an active-method three-dimensional information acquisition unit 411 of the three-dimensional information acquisition unit 41 acquires three-dimensional information DTa of the active-method application area by using the reflected light. A passive-method three-dimensional information acquisition unit 412 acquires three-dimensional information DTp of the passive-method application area on the basis of a plurality of captured images of different viewpoints. Therefore, it is possible to acquire three-dimensional information of a subject easily, speedily, and accurately.

### TECHNICAL FIELD

This technique relates to an information processing device, an information processing method, a program, and an image capturing device and can acquire three-dimensional information of a subject easily, speedily, and accurately.

### BACKGROUND ART

Conventionally, an active method and a passive method have been known as a method of acquiring three-dimensional information by using a principle of triangulation. As disclosed in, for example, Patent Literature 1, the active method is a method of, by projecting structured light onto a subject and capturing an image, acquiring three-dimensional information on the basis of the structured light in this captured image. Further, as disclosed in, for example, Patent Literature 2, the passive method is a method of acquiring three-dimensional information on the basis of an image feature without projecting structured light.

In the active method, it is possible to perform stable measurement with high accuracy within a range in which structured light can reach a subject. In a case of a far subject that structured light cannot reach, although the passive method has lower accuracy and stability, it is possible to acquire three-dimensional information by applying the passive method. Therefore, in, for example, Patent Literature 3, in a scene in which it is difficult to measure a distance by using the active method, the distance is measured by switching an image capturing mode using the active method to an image capturing mode using the passive method.

### CITATION LIST

### Patent Literature

Patent Literature 1: WO 2006/120759

Patent Literature 2: JP H9-79820A

Patent Literature 3: JP 2000-347095A

### DISCLOSURE OF INVENTION

### Technical Problem

By the way, in a case where a near subject and a far subject are included in an image capturing area, it is possible to acquire three-dimensional information with high accuracy by combining three-dimensional information in the image capturing mode using the active method with three-dimensional information in the image capturing mode using the passive method. However, in order to combine the three-dimensional information acquired by using the active method with the three-dimensional information acquired by using the passive method, it is necessary to perform work using dedicated software and a three-dimensional editor. Therefore, it is difficult to acquire three-dimensional information easily, speedily, and accurately.

In view of this, an object of this technology is to provide an information processing device, an information processing method, a program, and an image capturing device, each of which is capable of acquiring three-dimensional information of a subject easily, speedily, and accurately.

### Solution to Problem

A first aspect of the present technology resides in an information processing device including: an area determination unit configured to determine an active-method application area in which three-dimensional information is acquired on the basis of reflected light of a projected predetermined luminous flux and a passive-method application area that is another area; and a three-dimensional information acquisition unit configured to, on the basis of an area determination result obtained by the area determination unit, acquire the three-dimensional information by using the reflected light in the active-method application area and acquire three-dimensional information on the basis of a plurality of captured images of different viewpoints in the passive-method application area.

In this technology, the area determination unit determines the active-method application area and the passive-method application area. The area determination unit determines, as the active-method application area, a subject area in which reflected light is obtained when, for example, a laser beam for measuring a distance on the basis of a flight time elapsed before structured light or reflected light returns is projected as a predetermined luminous flux. For example, the area determination unit determines the active-method application area on the basis of a difference image of a captured image captured by projecting a predetermined luminous flux and a captured image captured without projecting a predetermined luminous flux, the captured images being captured in a state in which image capturing directions and angles of view are the same. Further, the area determination unit may obtain a boundary of a subject on the basis of luminance distribution of a captured image captured by projecting a luminous flux for area determination and determine, as the active-method application area, a subject area in which luminance of the subject has a higher level than a predetermined level. Further, the area determination unit may determine an area in which a texture exists in the captured image as the passive-method application area.

On the basis of the area determination result obtained by the area determination unit, the three-dimensional information acquisition unit acquires the three-dimensional information by using the reflected light in the active-method application area and acquires the three-dimensional information on the basis of the plurality of captured images of the different viewpoints in the passive-method application area. Further, the three-dimensional information acquisition unit acquires three-dimensional information on the basis of a plurality of captured images of different viewpoints also in the active-method application area. Furthermore, the three-dimensional information acquisition unit obtains a scale ratio of the three-dimensional information acquired on the basis of the plurality of captured images of the different viewpoints in the active-method application area to the three-dimensional information acquired by using the reflected light and causes a scale of the three-dimensional information of the passive-method application area acquired on the basis of the plurality of captured images of the different viewpoints to match a scale of the three-dimensional information of the active-method application area acquired by using the reflected light. Further, an information integration unit performs integration of pieces of three-dimensional information by using, in the active-method application area, the three-dimensional information acquired by using the reflected light and by using, in the passive-method application area, the three-dimensional information that has been acquired on the basis of the plurality of captured images of the different viewpoints and has been subjected to scale adjustment.

A second aspect of the present technology resides in an information processing method including: a step of determining, by an area determination unit, an active-method application area in which three-dimensional information is acquired on the basis of reflected light of a projected predetermined luminous flux and a passive-method application area that is another area; and a step of acquiring, by a three-dimensional information acquisition unit, on the basis of an area determination result obtained by the area determination unit, the three-dimensional information by using the reflected light in the active-method application area and acquiring three-dimensional information on the basis of a plurality of captured images of different viewpoints in the passive-method application area.

A third aspect of the present technology resides in a program for causing a computer to execute processing in which a captured image acquires three-dimensional information of a subject area, the program causing the computer to execute a procedure of determining an active-method application area in which three-dimensional information is acquired on the basis of reflected light of a projected predetermined luminous flux and a passive-method application area that is another area, and a procedure of acquiring, on the basis of on a determination result of the active-method application area and the passive-method application area, the three-dimensional information by using the reflected light in the active-method application area and acquiring three-dimensional information on the basis of a plurality of captured images of different viewpoints in the passive-method application area.

Note that a program of the present technology is, for example, a program that can be provided to a general-purpose computer capable of executing various program codes by a storage medium or communication medium for providing a program in a computer readable form (for example, the storage medium such as an optical disc, a magnetic disk, or a semiconductor memory or the communication medium such as a network). Such a program is provided in a computer readable form, and therefore processing corresponding to the program is realized in a computer.

A fourth aspect of the present technology resides in an image capturing device including: an image capturing unit configured to generate a captured image; a control unit configured to control the image capturing unit so that the image capturing unit generates the captured image in a state in which a predetermined luminous flux is projected and generates the captured image in a state in which the predetermined luminous flux is not projected; an area determination unit configured to determine an active-method application area in which three-dimensional information is acquired on the basis of reflected light of the projected predetermined luminous flux and a passive-method application area that is another area; and a three-dimensional information acquisition unit configured to, on the basis of a determination result obtained by the area determination unit, acquire the three-dimensional information by using the reflected light in the active-method application area and acquire three-dimensional information on the basis of a plurality of captured images of different viewpoints in the passive-method application area.

In this technology, the area determination unit determines the active-method application area and the passive-method application area in accordance with brightness at the time of capturing an image, an image capturing mode, an image signal of the captured image, or the like. Further, when a storage unit is provided and stores the plurality of captured images of the different viewpoints and the area determination result, it is possible to acquire the three-dimensional information of the passive-method application area in a case where a plurality of captured images of different viewpoints are generated while the image capturing unit and the like are being moved or in a case where offline processing is performed. Furthermore, when the storage unit stores the three-dimensional information acquired by using the reflected light, it is possible to acquire the three-dimensional information of the active-method application area and the three-dimensional information of the passive-method application area at the time of offline processing.

### Advantageous Effects of Invention

According to this technology, an active-method application area in which three-dimensional information is acquired on the basis of reflected light of a projected predetermined luminous flux and a passive-method application area that is the other area are determined. Further, on the basis of this area determination result, three-dimensional information is acquired by using the reflected light in the active-method application area and three-dimensional information is acquired on the basis of a plurality of captured images of different viewpoints in the passive-method application area. Therefore, it is possible to acquire three-dimensional information of a subject easily, speedily, and accurately. Note that effects described in the present specification are merely examples and are not limited, and additional effects may be exhibited.

### BRIEF DESCRIPTION OF DRAWINGS

FIG. 1 shows a configuration of an information processing device.

FIG. 2 is a flowchart showing an example of operation of an information processing device.

FIG. 3 shows an example of a captured image captured without projecting structured light.

FIG. 4 shows an example of a captured image captured by projecting structured light.

FIG. 5 shows a difference image.

FIG. 6 shows a boundary between an area in which reflected light of structured light is included and an area in which reflected light of structured light is not included.

FIG. 7 shows an area determination result.

FIG. 8 shows an example of a configuration of a first embodiment.

FIG. 9 is a flowchart showing an example of operation of the first embodiment.

FIG. 10 shows a timing chart showing an example of operation of an image capturing device.

### MODE(S) FOR CARRYING OUT THE INVENTION

Hereinafter, embodiments for implementing the present technology will be described. Note that description will be provided in the following order.

1. Configuration of information processing device

2. Operation of information processing device

3. First embodiment
3-1. Configuration of first embodiment
3-2. Operation of first embodiment

4. Other embodiments

### 1. Configuration of Information Processing Device

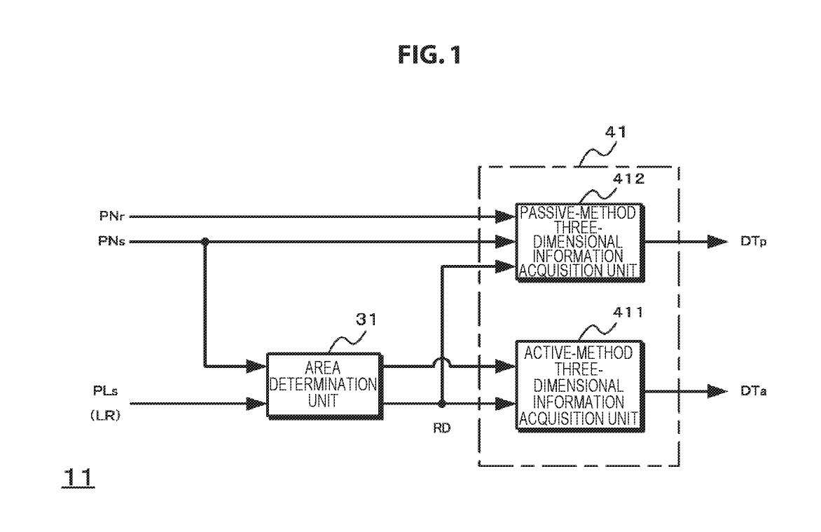

FIG. 1 shows a configuration of an information processing device in the present technology. An information processing device 11 includes an area determination unit 31 and a three-dimensional information acquisition unit 41.

The area determination unit 31 determines an active-method application area in which three-dimensional information is acquired by using reflected light of a projected predetermined luminous flux and a passive-method application area that is the other area. The area determination unit 31 determines the active-method application area and the passive-method application area on the basis of a captured image PLs captured by projecting a predetermined luminous flux and a captured image PNs captured without projecting a luminous flux, the captured images being captured in a state in which, for example, image capturing directions and angles of view are the same. Further, the area determination unit 31 determines the active-method application area and the passive-method application area by using, for example, reflected light obtained by projecting a predetermined luminous flux onto a subject.

In a case where the area determination unit 31 determines the active-method application area and the passive-method application area on the basis of the captured image PLs and the captured image PNs, the area determination unit 31 generates a difference image of the captured image PLs and the captured image PNs. Herein, the image capturing directions and the angles of view of the captured image PLs and the captured image PNs are the same. Therefore, in the captured image PLs captured by projecting structured light, for example, coded pattern light as a predetermined luminous flux, an image of a subject that the structured light cannot reach is the same as the captured image PNs captured without projecting the structured light. Therefore, the difference image is an image showing a subject that the structured light reaches. Therefore, the area determination unit 31 determines a subject area that the structured light reaches as the active-method application area in which three-dimensional information is acquired by using the structured light and determines the other area as the passive-method application area in which three-dimensional information is acquired without using the structured light. The area determination unit 31 outputs an area determination result RD to the three-dimensional information acquisition unit 41.

On the basis of the area determination result obtained by the area determination unit 31, in the active-method application area, the three-dimensional information acquisition unit 41 acquires three-dimensional information (for example, three-dimensional coordinate values or three-dimensional coordinate values and color information)) by using reflected light of a projected predetermined luminous flux. Further, in the passive-method application area, the three-dimensional information acquisition unit 41 acquires three-dimensional information on the basis of the captured image PNs and a captured image PNr of a different viewpoint captured without projecting a predetermined luminous flux. The three-dimensional information acquisition unit 41 includes, for example, an active-method three-dimensional information acquisition unit 411 and a passive-method three-dimensional information acquisition unit 412.

The active-method three-dimensional information acquisition unit 411 acquires three-dimensional information of the active-method application area by using reflected light of a projected predetermined luminous flux. In a case where, for example, coded pattern light that is structured light is projected, the active-method three-dimensional information acquisition unit 411 acquires three-dimensional information as disclosed in Patent Literature 1. That is, the active-method three-dimensional information acquisition unit 411 acquires three-dimensional information (hereinafter, referred to as “active-method three-dimensional information”) DTa by decoding pattern reflected light in a captured image captured in a state in which pattern light is projected and identifying a position of the active-method application area. When the active method is used as described above, it is possible to acquire highly accurate three-dimensional information with extremely high stability, as compared to a case of using the passive method. Further, when the active method is used, it is possible to measure an actual position of the active-method application area.

The passive-method three-dimensional information acquisition unit 412 acquires three-dimensional information of the passive-method application area on the basis of a plurality of captured images of different viewpoints. The passive-method three-dimensional information acquisition unit 412 acquires three-dimensional information (hereinafter, referred to as “passive-method three-dimensional information”) DTp by calculating, for example, a corresponding point between the captured image PNs and the captured image PNr of different viewpoints and identifying a position of the corresponding point on the basis of the principle of triangulation.

### 2. Operation of Information Processing Device

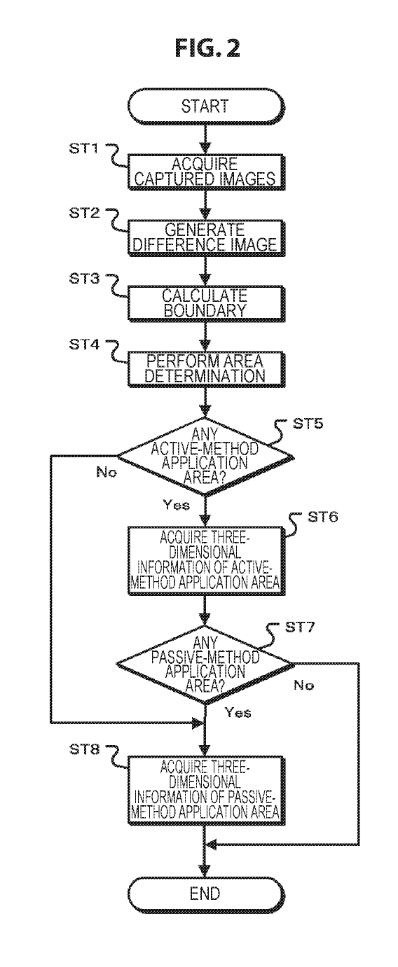

Next, operation of the information processing device in a case of performing area determination on the basis of a difference image will be described with reference to FIGS. 2 to 7.

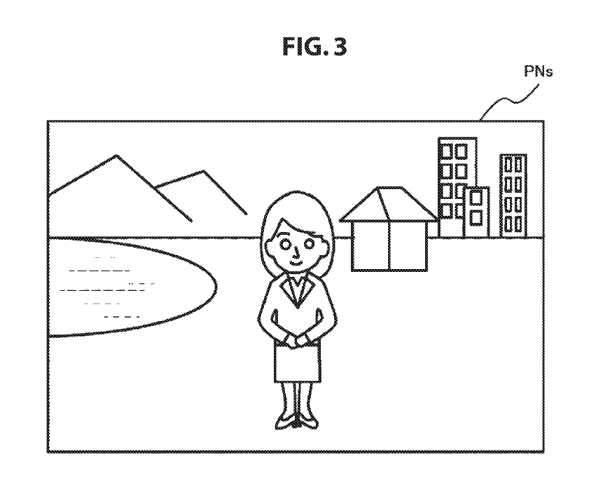

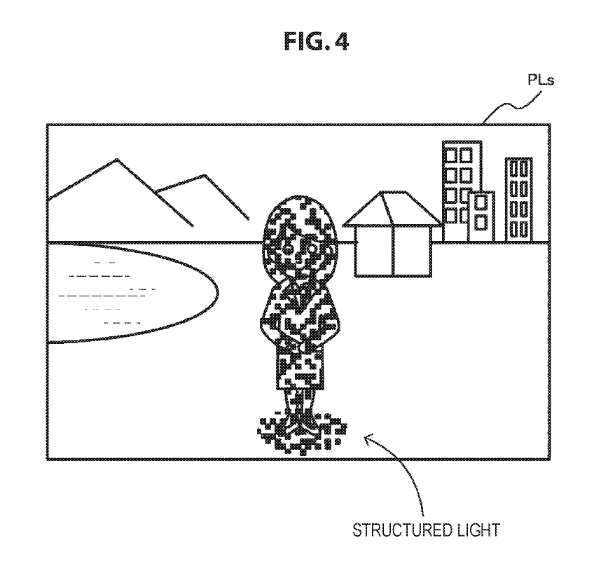

FIG. 2 is a flowchart showing an example of the operation of the information processing device. In Step ST1, the information processing device 11 acquires captured images. The information processing device 11 acquires a captured image PLs captured by projecting structured light, a captured image PNs captured without projecting structured light, and a captured image PNr of a different viewpoint captured without projecting structured light, and the processing proceeds to Step ST2. Note that FIG. 3 shows an example of the captured image PNs captured without projecting structured light, and FIG. 4 shows an example of the captured image PLs captured by projecting structured light.

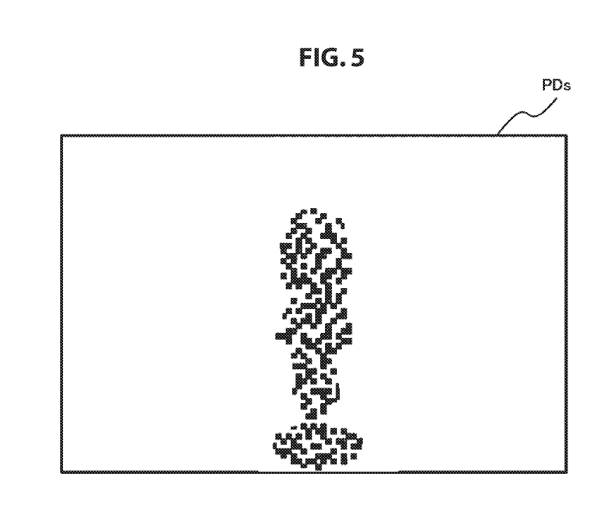

In Step ST2, the information processing device 11 generates a difference image. The area determination unit 31 of the information processing device 11 calculates a difference between the two captured images PLs and PNs acquired in Step ST1 and generates a difference image PDs as shown in FIG. 5, and the processing proceeds to Step ST3.

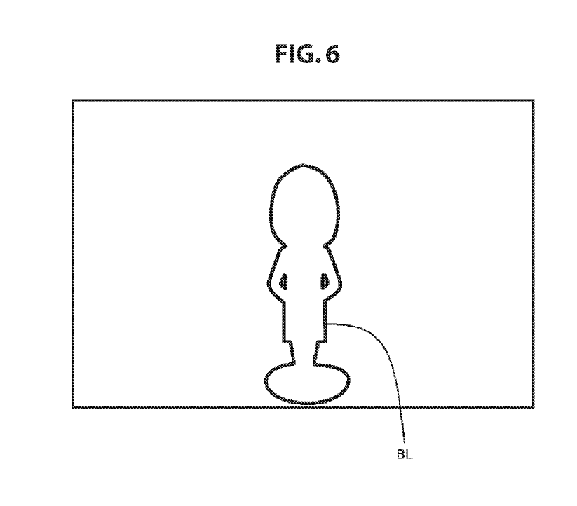

In Step ST3, the information processing device 11 calculates a boundary. The area determination unit 31 of the information processing device 11 calculates a boundary between an area in which reflected light of the structured light is included and an area in which reflected light of the structured light is not included on the basis of the difference image PDs generated in Step ST2, and the processing proceeds to Step ST4. Note that FIG. 6 shows a boundary BL between the area in which the reflected light of the structured light is included and the area in which the reflected light of the structured light is not included.

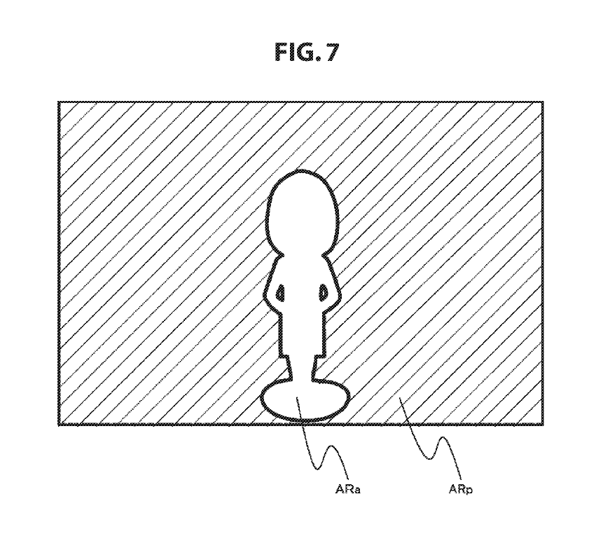

In Step ST4, the information processing device 11 performs area determination. The area determination unit 31 of the information processing device 11 generates an area determination result RD showing that the area in which the reflected light of the structured light is included, the area being divided by the calculated boundary, is determined as an active-method application area and the other area in which the reflected light of the structured light is not included is determined as a passive-method application area, and the processing proceeds to Step ST5. FIG. 7 shows an active-method application area ARa and a passive-method application area ARp shown by the area determination result.

In Step ST5, the information processing device 11 determines whether or not the active-method application area exists in the captured image. In a case where the three-dimensional information acquisition unit 41 of the information processing device determines that the active-method application area exists in the captured image on the basis of the area determination result RD, the processing proceeds to Step ST6, and, in a case where the three-dimensional information acquisition unit 41 thereof determines that the active-method application area does not exist therein, the processing proceeds to Step ST8.

In Step ST6, the information processing device 11 acquires three-dimensional information of the active-method application area. The three-dimensional information acquisition unit 41 of the information processing device 11 acquires active-method three-dimensional information, which is three-dimensional information of the active-method application area, by using the active method, and the processing proceeds to Step ST7.

In Step ST7, the information processing device 11 determines whether or not the passive-method application area exists in the captured image. In a case where the three-dimensional information acquisition unit 41 of the information processing device determines that the passive-method application area exists in the captured image, the processing proceeds to Step ST8. Further, in a case where the three-dimensional information acquisition unit 41 determines that the passive-method application area does not exist in the captured image, the whole captured image is the active-method application area and the three-dimensional information of the active-method application area has already been acquired in Step ST6, and therefore the processing is terminated.

In Step ST8, the information processing device 11 acquires three-dimensional information of the passive-method application area. The three-dimensional information acquisition unit 41 of the information processing device 11 acquires passive-method three-dimensional information, which is three-dimensional information of the passive-method application area, by using the passive method, and the processing is terminated.

As described above, according to the information processing device in the present technology, an area to which the active method is applied and an area to which the passive method is applied are determined by area determination. Furthermore, on the basis of an area determination result, three-dimensional information is acquired by using the passive method in an area in which three-dimensional information cannot be acquired by using the active method. Therefore, it is possible to reduce throughput and acquire three-dimensional information easily, speedily, and accurately. Further, it is possible to prevent reduction in accuracy of three-dimensional information of the active-method application area, as compared to a case of integrating pieces of three-dimension acquired in the same area by using the active method and the passive method.

### 3. First Embodiment

Next, a first embodiment of the information processing device in the present technology will be described. In the first embodiment, for example, the information processing device further includes an image capturing unit and a projection unit for projecting a predetermined luminous flux. Further, in the first embodiment, images of a subject are captured from different directions by moving the image capturing unit and the projection unit. This movement may be performed by, for example, a user holding the image capturing unit and the projection unit in his/her hands or fixing the image capturing unit and the projection unit to a mounting base or the like (for example, pan tilter) and causing this mounting base or the like to run on a rail, a road surface, a floor surface, or the like automatically or in response to an instruction from the user. Furthermore, in the first embodiment, a so-called structure form motion (SFM) method is used to acquire three-dimensional information by using the passive method.

### 3-1. Configuration of First Embodiment

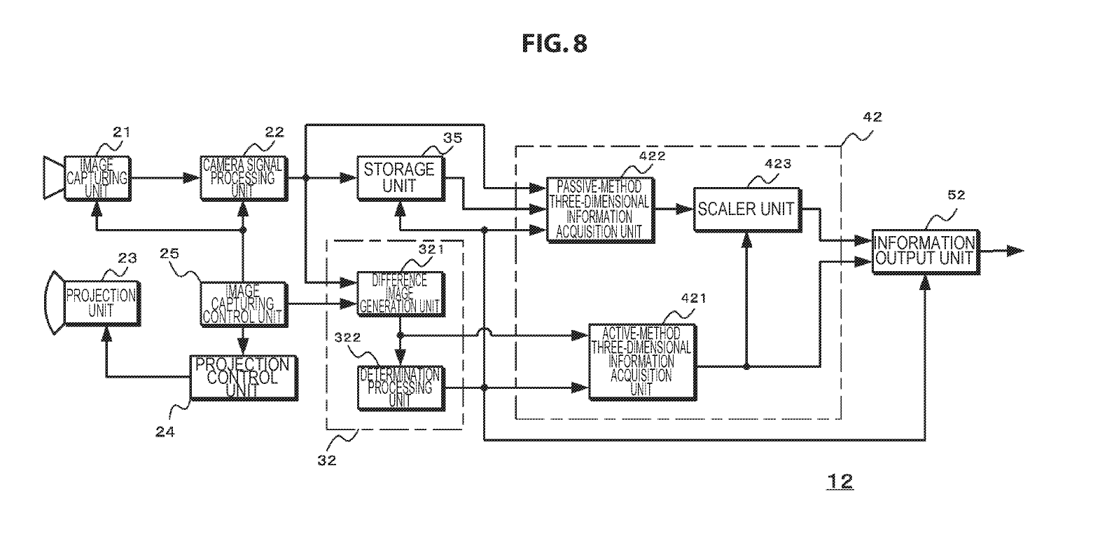

FIG. 8 shows an example of a configuration of the first embodiment. An image capturing device 12 serving as the information processing device including the image capturing unit and the projection unit includes an image capturing unit 21, a camera signal processing unit 22, a projection unit 23, a projection control unit 24, an image capturing control unit 25, an area determination unit 32, a storage unit 35, a three-dimensional information acquisition unit 42, and an information output unit 52.

The image capturing unit 21 captures an image on the basis of a control signal from the image capturing control unit 25, generates an image signal, and outputs the image signal to the camera signal processing unit 22. The camera signal processing unit 22 performs camera signal processing, such as adjustment of luminance and color and noise reduction, on the image signal generated in the image capturing unit 21 and outputs the image signal subjected to the processing to the area determination unit 32, the storage unit 35, and the three-dimensional information acquisition unit 42.

The projection unit 23 projects a predetermined luminous flux, for example, structured light onto a subject. The projection unit 23 projects, for example, structured light having a specified pattern or the like onto the subject on the basis of a control signal from the projection control unit 24. The projection control unit 24 controls the projection unit 23 on the basis of a control signal from the image capturing control unit 25 and causes the projection unit 23 to project structured light onto the subject. The projection unit 23 may be provided to be fixed to a main body of the image capturing device 12 or may be detachably provided to the main body.

The image capturing control unit 25 controls operation of the image capturing unit 21 and the camera signal processing unit 22. Further, the image capturing control unit 25 causes the projection control unit 24 to control the projection unit 23 so that an image signal of a captured image obtained in a state in which structured light is projected and an image signal of a captured image obtained in a state in which structured light is not projected can be generated. Further, as described below, the image capturing control unit 25 controls operation of the area determination unit 32 so that the area determination unit 32 can perform area determination by using the image signal of the captured image obtained in a state in which the structured light is projected and the image signal of the captured image obtained in a state in which the structured light is not projected.

By using reflected light of a projected predetermined luminous flux, the area determination unit 32 determines an active-method application area in which three-dimensional information is acquired on the basis of the reflected light and a passive-method application area in which three-dimensional information is acquired not on the basis of the reflected light. The area determination unit 32 includes, for example, a difference image generation unit 321 and a determination processing unit 322.

The difference image generation unit 321 generates a difference image of a captured image captured by projecting structured light and a captured image captured without projecting structured light, the captured images being captured in a state in which image capturing directions and angle of views of the image capturing unit 21 are the same. Herein, because the image capturing directions and the angles of view of the image capturing unit 21 are the same, an image of a subject that the structured light cannot reach in the captured image captured by projecting the structured light is the same as the captured image captured without projecting the structured light. Therefore, the difference image is an image showing a subject that the structured light reaches.

The determination processing unit 322 determines an active-method application area in which three-dimensional information is acquired by using the structured light and a passive-method application area in which three-dimensional information is acquired without using the structured light on the basis of the difference image. As described above, the difference image shows the subject that the structured light reaches. Therefore, the determination processing unit 322 determines a subject area that the structured light reaches as the active-method application area in which three-dimensional information is acquired by using the structured light and determines the other area as the passive-method application area in which three-dimensional information is acquired without using the structured light. The determination processing unit 322 outputs an area determination result to the storage unit 35 and the three-dimensional information acquisition unit 42.

In a case where passive-method three-dimensional information is acquired by using captured images obtained by capturing images of a subject from different directions while the image capturing unit and the projection unit being moved as described below, the storage unit 35 stores captured images obtained in a state in which structured light is not projected and the area determination result. Further, the storage unit 35 outputs image signals of the stored captured images and the stored area determination result to a passive-method three-dimensional information acquisition unit 422 of the three-dimensional information acquisition unit 42.

On the basis of the area determination result obtained by the area determination unit 32, the three-dimensional information acquisition unit 42 acquires three-dimensional information (for example, three-dimensional coordinate values or three-dimensional coordinate values and color information) by using reflected light of a projected predetermined luminous flux in the active-method application area. Further, the three-dimensional information acquisition unit 42 acquires three-dimensional information on the basis of a plurality of captured images of different viewpoints in the passive-method application area. The three-dimensional information acquisition unit 42 includes, for example, an active-method three-dimensional information acquisition unit 421, the passive-method three-dimensional information acquisition unit 422, and a scaler unit 423.

The active-method three-dimensional information acquisition unit 421, as well as the above-mentioned active-method three-dimensional information acquisition unit 411, acquires three-dimensional information of the active-method application area by using reflected light of a projected predetermined luminous flux. The active-method three-dimensional information acquisition unit 421 outputs the three-dimensional information acquired in the active-method application area to the scaler unit 423 and the information output unit 52. Further, in a case where images are captured while the image capturing unit 21 is being moved, a coordinate system (camera coordinate system) based on the image capturing unit 21 is such that a camera coordinate system before movement does not match a camera coordinate system after the movement. Therefore, the active-method three-dimensional information acquisition unit 421 sets, for example, a coordinate system of a first position of the image capturing unit 21 as a world coordinate system and thereafter converts three-dimensional information of a camera coordinate system acquired at a position after the image capturing unit 21 is moved into three-dimensional information of the world coordinate system. As described above, the active-method three-dimensional information acquisition unit 421 acquires three-dimensional information using the world coordinate system. Note that movement of the image capturing unit 21 may be detected by using a sensor or the like, or processing may be performed by using movement of the image capturing unit 21 detected by using the SFM method in the passive-method three-dimensional information acquisition unit 422.

The passive-method three-dimensional information acquisition unit 422 acquires three-dimensional information of the passive-method application area on the basis of a plurality of captured images of different viewpoints. The passive-method three-dimensional information acquisition unit 422 acquires the three-dimensional information on the basis of the plurality of captured images of the different viewpoints by using, for example, the SFM method. Note that, in a case where the structure form motion (SFM) method is used as the passive method, the three-dimensional information acquired by the passive-method three-dimensional information acquisition unit 422 is information indicating a relative position. The passive-method three-dimensional information acquisition unit 422 outputs the acquired three-dimensional information to the scaler unit 423. Further, the passive-method three-dimensional information acquisition unit 422, as well as the passive-method three-dimensional information acquisition unit 412, sets, for example, a coordinate system of a first position of the image capturing unit 21 as a world coordinate system. Thereafter, the passive-method three-dimensional information acquisition unit 422 converts three-dimensional information of a camera coordinate system acquired at a position after the image capturing unit 21 is moved into three-dimensional information of the world coordinate system, thereby acquiring three-dimensional information using the world coordinate system.

The scaler unit 423 calculates a scale ratio of the passive-method three-dimensional information to the active-method three-dimensional information. The scaler unit 423 calculates the scale ratio on the basis of three-dimensional coordinate values by using the active-method three-dimensional information of the active-method application area acquired by the active-method three-dimensional information acquisition unit 421 and the passive-method three-dimensional information of the active-method application area acquired by the passive-method three-dimensional information acquisition unit 422. Furthermore, the scaler unit 423 performs scale adjustment on the passive-method three-dimensional information by using the calculated scale ratio, converts the passive three-dimensional information indicating a relative position into information having a scale equal to a scale of the active-method three-dimensional information, and outputs the information to the information output unit 52.

The information output unit 52 outputs the active-method three-dimensional information of the active-method application area from the active-method three-dimensional information acquisition unit 421 and the passive-method three-dimensional information from the scaler unit 423. Further, the information output unit 52 may individually output the active-method three-dimensional information from the active-method three-dimensional information acquisition unit 421, the passive-method three-dimensional information from the scaler unit 423, and the area determination result from the area determination unit 32. Further, the information output unit 52 may have an information integration function of integrating active-method three-dimensional information with passive-method three-dimensional information. In the active-method application area in the captured image, the information output unit 52 uses the active-method three-dimensional information acquired by using reflected light on the basis of, for example, the area determination result from the area determination unit 32. Further, in the passive-method application area, the active-method three-dimensional information and the passive-method three-dimensional information are integrated by using the passive-method three-dimensional information from the scaler unit 423 which is three-dimensional information that has been acquired on the basis of the plurality of captured images of the different viewpoints and has been subjected to scale adjustment. The information output unit 52 outputs the integrated three-dimensional information.

### 3-2. Operation of First Embodiment

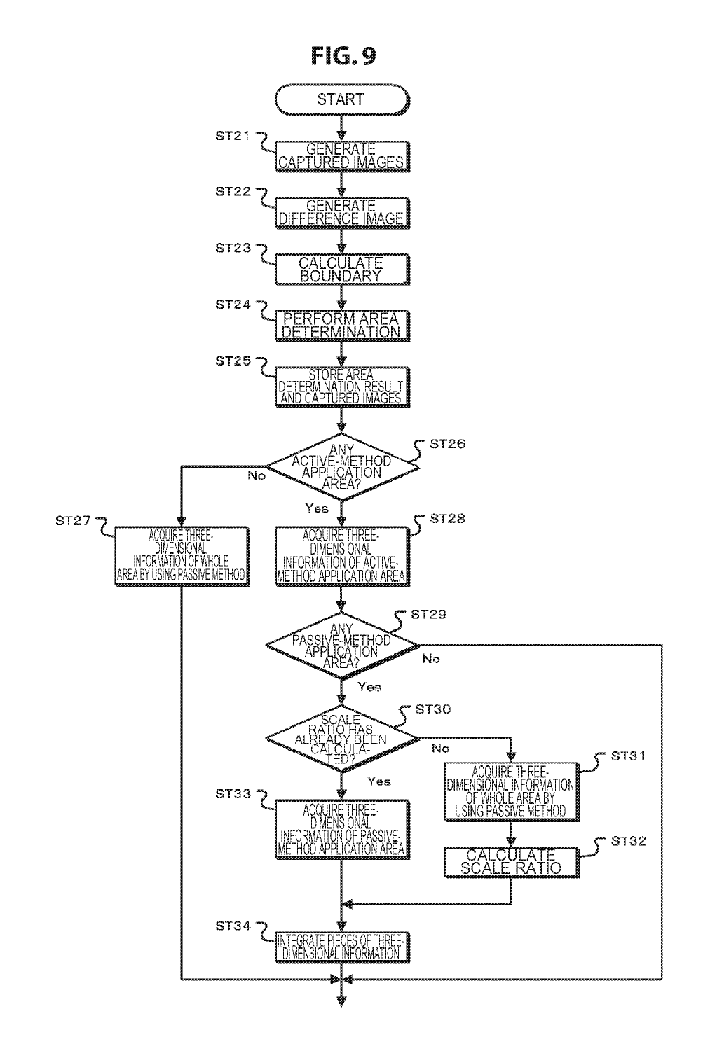

FIG. 9 is a flowchart showing an example of operation of the first embodiment. In Step ST21, the image capturing device 12 generates captured images. The image capturing control unit 25 of the image capturing device 12 controls the image capturing unit 21, the projection unit 23, and the like to generate a captured image captured by projecting structured light and a captured image captured without projecting structured light, and the processing proceeds to Step ST22.

In Step ST22, the image capturing device 12 generates a difference image. The area determination unit 31 of the image capturing device 12 generates a difference image of the two captured images generated in Step ST21, and the processing proceeds to Step ST23.

In Step ST23, the image capturing device 12 calculates a boundary. The area determination unit 32 of the image capturing device 12 calculates a boundary between an area in which reflected light of the structured light is included and an area in which reflected light of the structured light is not included on the basis of the difference image generated in Step ST22, and the processing proceeds to Step ST24.

In Step ST24, the image capturing device 12 performs area determination. The area determination unit 32 of the image capturing device 12 determines the area in which the reflected light of the structured light is included, the area being divided by the calculated boundary, as an active-method application area and the other area as a passive-method application area, and the processing proceeds to Step ST25.

In Step ST25, the image capturing device 12 stores an area determination result and the captured images. The storage unit 35 of the information processing device stores the area determination result obtained in Step ST23 and the captured image in the passive-method application area generated in Step ST21, and the processing proceeds to Step ST26. Note that it is considered that the whole captured image is determined as the active-method application area or the passive-method application area. In this case, information capable of identifying the whole captured image as the active-method application area or the passive-method application area is stored.

In Step ST26, the image capturing device 12 determines whether or not the active-method application area exists in the captured image. In a case where the three-dimensional information acquisition unit 42 of the information processing device determines that the active-method application area does not exist in the captured image, the processing proceeds to Step ST27, and, in a case where the three-dimensional information acquisition unit 42 thereof determines that the active-method application area exists therein, the processing proceeds to Step ST28.

In Step ST27, the image capturing device 12 acquires three-dimensional information of the whole area by using the passive method. Because the active-method application area does not exists in the captured image, that is, the whole captured image is the passive-method application area, the three-dimensional information acquisition unit 42 of the image capturing device 12 acquires three-dimensional information of the whole area in the captured image by using the passive method, processing regarding the captured images acquired in Step ST21 is terminated. Note that acquisition of three-dimensional information using the passive method is performed after a captured image of a different viewpoint captured without projecting structured light is generated. Specifically, the three-dimensional information acquisition unit 42 acquires passive-method three-dimensional information by using the captured image captured without projecting structured light and a captured image of a different viewpoint stored on the storage unit.

In Step ST28, the image capturing device 12 acquires three-dimensional information of the active-method application area. The three-dimensional information acquisition unit 42 of the image capturing device 12 acquires active-method three-dimensional information, which is three-dimensional information of the active-method application area, by using the active method, and the processing proceeds to Step ST29.

In Step ST29, the image capturing device 12 determines whether or not the passive-method application area exists in the captured image. In a case where the three-dimensional information acquisition unit 42 of the information processing device determines that the passive-method application area does not exist in the captured image, that is, the whole captured image is the active-method application area, the three-dimensional information of the active-method application area has already been acquired in Step ST28, and therefore the processing regarding the captured images acquired in Step ST21 is terminated. Further, in a case where the three-dimensional information acquisition unit 42 of the information processing device determines that the passive-method application area exists in the captured image, the processing proceeds to Step ST30.

In Step ST30, the image capturing device 12 determines whether or not a scale ratio has already been calculated. In a case where the three-dimensional information acquisition unit 42 of the image capturing device 12 has not calculated a scale ratio of the active-method three-dimensional information to the passive-method three-dimensional information, the processing proceeds to Step ST31, and, in a case where the three-dimensional information acquisition unit 42 thereof has calculated the scale ratio, the processing proceeds to Step ST33.

In Step ST31, the image capturing device 12 acquires three-dimensional information of the whole area by using the passive method. The three-dimensional information acquisition unit 42 of the image capturing device 12 acquires three-dimensional information of the whole area in the captured image by using the passive method, and the processing proceeds to Step ST32. Note that acquisition of three-dimensional information using the passive method is performed after a captured image of a different viewpoint captured without projecting structured light is generated. Specifically, the three-dimensional information acquisition unit 42 acquires passive-method three-dimensional information by using the captured image captured without projecting structured light and a captured image of a different viewpoint stored on the storage unit.

In Step ST32, the image capturing device 12 calculates the scale ratio. By performing the processing in Step ST28 and Step ST31, the three-dimensional information acquisition unit 42 of the image capturing device 12 has acquired the three-dimensional information of the active-method application area by using the active method and the passive method. Further, because the active method is used, the three-dimensional information of the active-method application area has been acquired on a highly accurate scale. Therefore, the three-dimensional information acquisition unit 42 calculates the scale ratio on the basis of the pieces of the three-dimensional information of the same area acquired by using the active method and the passive method so that a scale of the passive-method three-dimensional information matches a scale of the active-method three-dimensional information, and the processing proceeds to Step ST34.

In Step ST33, the image capturing device 12 acquires three-dimensional information of the passive-method application area. The three-dimensional information acquisition unit 42 of the image capturing device 12 acquires passive-method three-dimensional information, which is three-dimensional information of the passive-method application area, by using the passive method, and the processing proceeds to Step ST34. Note that acquisition of the passive-method three-dimensional information is performed after a captured image of a different viewpoint captured without projecting structured light is generated. Specifically, the three-dimensional information acquisition unit 42 acquires the passive-method three-dimensional information by using the captured image captured without projecting structured light, a captured image of a different viewpoint, and the area determination result stored on the storage unit.

In Step ST34, the image capturing device 12 integrates pieces of the three-dimensional information. The information output unit 52 of the image capturing device 12 causes the scale of the passive-method three-dimensional information to match the scale of the active-method three-dimensional information by using the scale ratio calculated in Step ST32. Thereafter, the active-method three-dimensional information and the passive-method three-dimensional information subjected to scale adjustment are integrated. That is, the information output unit 52 integrates pieces of the three-dimensional information so that the active-method three-dimensional information is shown in the active-method application area in the captured image and the passive-method three-dimensional information having a scale equal to that of the active-method three-dimensional information is shown in the passive-method application area.

Thereafter, when three-dimensional information is acquired while, for example, the image capturing device 12 is being moved around a desired subject by repeatedly performing the processing from Step ST21 to Step ST34 while moving the image capturing device 12, it is possible to reconstruct the whole shape of the desired subject on the basis of the acquired three-dimensional information.

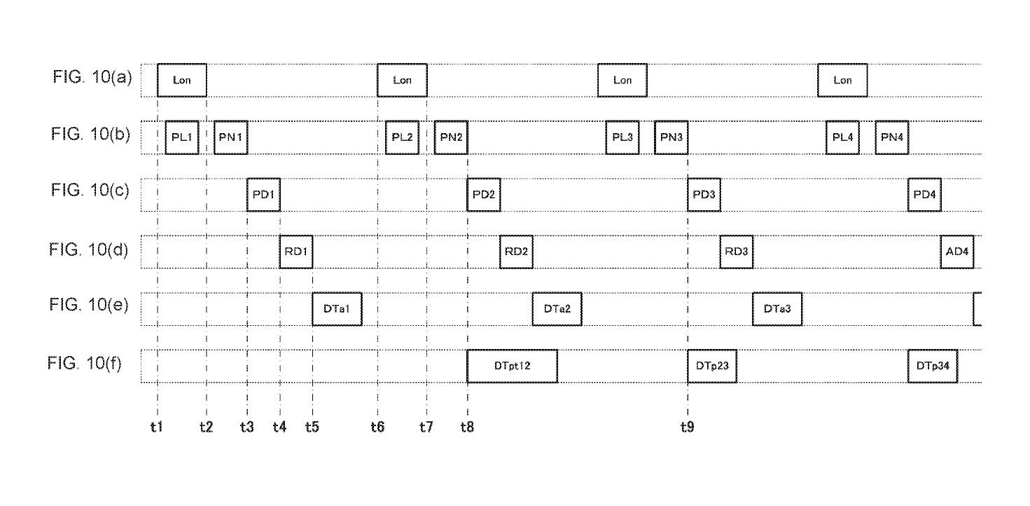

FIG. 10 shows an example of a timing chart showing operation of the image capturing device. Note that (a) of FIG. 10 shows operation of the projection unit 23, and (b) of FIG. 10 shows operation of the image capturing unit 21. Further, (c) of FIG. 10 shows operation of the difference image generation unit 321, and (d) of FIG. 10 shows operation of the determination processing unit 322. Furthermore, (e) of FIG. 10 shows operation of the active-method three-dimensional information acquisition unit 421, and (f) of FIG. 10 shows operation of the passive-method three-dimensional information acquisition unit 422.

The projection unit 23 projects structured light (Lon) in a period of time from a time point t1 to a time point t2. The image capturing unit 21 generates a captured image PL1 in this period of time. Thereafter, projection of the structured light is terminated, and the image capturing unit 21 generates a captured image PN1 in a state in which the structured light is not projected.

The difference image generation unit 321 generates a difference image PD1 of the captured image PL1 and the captured image PN1 at, for example, a time point t3 at which generation of the captured image PL1 and the captured image PN1 is completed.

The determination processing unit 322 starts area determination at, for example, a time point t4 at which generation of the difference image PD1 is completed and generates an area determination result RD1.

The active-method three-dimensional information acquisition unit 421 starts acquirement of active-method three-dimensional information DTa1 at, for example, a time point t5 at which generation of the area determination result RD1 is completed. The active-method three-dimensional information acquisition unit 421 acquires the active-method three-dimensional information DTa1 from an active-method application area shown by the area determination result RD1 on the basis of reflected light of the structured light in the difference image PD1 (or the captured image PL1).

Further, the image capturing device 12 stores the captured image PN1 captured in a state in which the structured light is not projected and the area determination result RD1 on the storage unit 35.

Next, the image capturing device 12 (or the image capturing unit 21 and the projection unit 23) is moved and captures an image from a different viewpoint position. That is, the projection unit 23 projects structured light (Lon) in a period of time from a time point t6 to a time point t7. The image capturing unit 21 generates a captured image PL2 in this period of time. Thereafter, the image capturing unit 21 generates a captured image PN2 in a state in which the structured light is not projected.

Herein, when the captured image PN2 is generated, the plurality of captured images PN1 and PN2 of different viewpoints are generated, and therefore acquisition of passive-method three-dimensional information is started at, for example, a time point t8 at which generation of the captured image PN2 is completed. Further, the passive-method three-dimensional information has not been acquired at this time point, and therefore a scale ratio has also not been calculated. Therefore, the passive-method three-dimensional information acquisition unit 422 acquires passive-method three-dimensional information DTpt12 in the whole area on the basis of the captured image PN1 stored on the storage unit 35 and the captured image PN2 generated in the image capturing unit 21.

The information output unit 52 calculates a scale ratio by using the active-method three-dimensional information DTa1 acquired by the active-method three-dimensional information acquisition unit 421, the passive-method three-dimensional information DTpt12 acquired by the passive-method three-dimensional information acquisition unit 422, and the area determination result RD1 in the storage unit 35. That is, the information output unit 52 calculates a scale ratio that causes a scale of passive-method three-dimensional information of the passive-method three-dimensional information DTpt12, the passive-method three-dimensional information being information on an area that the area determination result RD1 shows as the active-method application area, to match a scale of the active-method three-dimensional information. Furthermore, scale adjustment of the passive-method three-dimensional information of the passive-method application area is performed by using the calculated scale ratio, and the active-method three-dimensional information and the passive-method three-dimensional information subjected to the scale adjustment are integrated.

Further, the difference image generation unit 321 generates a difference image PD2 of the captured image PL2 and the captured image PN2 at the time point t8 at which generation of the captured image PL2 and the captured image PN2 is completed in the same way as the above-mentioned case. Further, the determination processing unit 322 starts area determination at a time point at which generation of the difference image PD2 is completed and generates an area determination result RD2 in the same way as the above-mentioned case.

The active-method three-dimensional information acquisition unit 421 starts acquirement of active-method three-dimensional information DTa2 at, for example, a time point at which generation of the area determination result RD2 is completed. The active-method three-dimensional information acquisition unit 421 acquires the active-method three-dimensional information DTa2 from the active-method application area shown by the area determination result RD2 on the basis of reflected light of the structured light in the difference image PD2 (or the captured image PL2).

Further, the image capturing device 12 stores the captured image PN2 captured in a state in which the structured light is not projected and the area determination result RD2 on the storage unit 35.

Next, the image capturing device 12 (or the image capturing unit 21 and the projection unit 23) is moved and generates a captured image PL3 and a captured image PN3 from a different viewpoint position in the same way as the above-mentioned case.

Herein, when the captured image PN3 is generated, the plurality of captured images PN2 and PN3 of different viewpoints are generated, and therefore the passive-method three-dimensional information acquisition unit 422 starts acquirement of passive-method three-dimensional information DTp23 at, for example, a time point t9 at which generation of the captured image PN3 is completed. Further, the scale ratio has been calculated at this time point. Therefore, the passive-method three-dimensional information acquisition unit 422 acquires the passive-method three-dimensional information DTp23 in the passive-method application area shown by the area determination result RD2 stored on the storage unit 35 on the basis of the captured image PN2 stored on the storage unit 35 and the captured image PN3 generated in the image capturing unit 21.

The information output unit 52 performs scale adjustment of the passive-method three-dimensional information of the passive-method application area by using the calculated scale ratio and integrates the active-method three-dimensional information with the passive-method three-dimensional information subjected to the scale adjustment.

Three-dimensional information can be sequentially acquired by repeatedly performing similar processing. Therefore, for example, it is possible to easily acquire the whole three-dimensional shape of a desired subject by capturing images while the image capturing device 12 is being moved around the desired subject. Further, in a case where the image capturing device 12 (or the image capturing unit 21 and the projection unit 23) is continuously moved, a difference between images caused by a parallax is reduced by reducing a time interval between a captured image captured in a state in which structured light is projected and a captured image captured in a state in which structured light is not projected. Therefore, it is possible to accurately perform area determination. Further, in a case where a plurality of captured images used in the passive-method three-dimensional information acquisition unit are captured images having a desired parallax, it is possible to acquire passive-method three-dimensional information easily and accurately, as compared to a case of using captured images having a small parallax.

Further, it is only necessary to calculate the scale ratio at least once in a series of acquisition of three-dimensional information, and an overhead caused by redundantly acquiring three-dimensional information from the active-method application area also by using the passive method is negligible. Therefore, an amount of time required to acquire three-dimensional information is not excessive. Furthermore, when three-dimensional information is acquired from the active-method application area by using the passive method at least once and scaling is performed at a scale ratio calculated on the basis of pieces of three-dimensional information (three-dimensional coordinate values) of a subject from which the pieces of three-dimensional information have been redundantly acquired, it is possible to integrate active-method three-dimensional information with passive-method three-dimensional information to form a single piece of three-dimensional information.

### 4. Other Embodiments

By the way, the area determination unit in the above-mentioned embodiment determines an active-method application area and a passive-method application area on the basis of a difference image of a captured image captured in a state in which a predetermined luminous flux is projected onto a subject and a captured image captured in a state in which the predetermined luminous flux is not projected. However, the area determination unit may determine the active-method application area and the passive-method application area by using other methods.

For example, in a case where an image is captured by using an illumination lamp, a near subject has, for example, a high average luminance level because of illumination light, and a far subject has a low average luminance level because illumination light hardly reaches the far subject. Therefore, an image is captured by projecting auxiliary light of an electronic flash or the like as a luminous flux for area determination. The area determination unit obtains a boundary of a subject on the basis of luminance distribution of the captured image at this time and determines a subject area in which luminance of a subject is higher than a threshold set in advance as the active-method application area and determines a subject having a luminance level lower than the threshold as the passive-method application area.

Further, the area determination unit may perform area determination in accordance with brightness at the time of capturing an image. For example, in a case where structured light is projected in an environment of intense sunlight, it is difficult to identify reflected light of the structured light from a subject. Therefore, in an image capturing environment in which identification of reflected light of structured light is difficult, the whole area is determined as the passive-method application area. Note that whether or not brightness at the time of capturing an image is brightness at which identification of reflected light of structured light is difficult is determined on the basis of, for example, an average luminance level of a captured image or a shutter speed or aperture value at which a captured image having optimal brightness is obtained.

Further, the area determination unit may perform area determination in accordance with an image capturing mode of the image capturing device. For example, in a case of an image capturing mode in which an image of scenery or the like is captured, a target subject exists at a far position in many cases, and therefore the whole area is determined as the passive-method application area. Further, in a case of an image capturing mode of a person or the like, a target subject exists at a near position in many cases, and therefore the active-method application area and the passive-method application area are determined on the basis of a difference image or the like.

Further, the area determination unit can also perform area determination on the basis of an image signal of a captured image. For example, in a case where a target subject is near, sharpness or an S/N ratio of an image of a subject at a far position is reduced in some cases. Therefore, an area in which the sharpness or the S/N ratio is lower than a threshold set in advance is determined as the passive-method application area.

Further, the area determination unit may determine the active-method application area and the passive-method application area in accordance with presence/absence of a texture. For example, the passive-method three-dimensional information acquisition unit calculates a corresponding point between a plurality of captured images of different viewpoints and identifies a position of the corresponding point on the basis of the principle of triangulation, thereby acquiring passive-method three-dimensional information. In this case, in a case where no texture exists as a subject, it is difficult to identify the position of the corresponding point. Therefore, the area determination unit determines presence/absence of a texture by image processing and determines an area in which no texture exists as the active-method application area.

By the way, a case where structured light indicating a coded pattern or the like is projected as a predetermined luminous flux has been described as an example in the above-mentioned embodiment. However, the predetermined luminous flux may be another luminous flux as long as three-dimensional information of the active-method application area can be acquired. For example, the predetermined luminous flux may be projected light for measuring a distance on the basis of a flight time elapsed before reflected light returns. That is, as in a case of a laser scanning using a digital mirror device (DMD) or a simultaneous-projection type time of flight (ToF) camera that irradiates infrared light or the like, a laser beam or infrared light is projected and three-dimensional information of the active-method application area is acquired on the basis of a flight time elapsed before reflected light returns. In this case, the area determination unit 31 in FIG. 1 performs area determination by using reflected light LR and determines an area in which the flight time cannot be measured as the passive-method application area.

Further, acquisition of passive-method three-dimensional information is not limited to a case using the SFM method. For example, the passive-method three-dimensional information may be acquired by using a stereo camera as the image capturing unit 21. In this case, a position of a viewpoint is clear, and therefore it is possible to easily acquire the passive-method three-dimensional information.

Further, each captured image captured in a state in which structured light is not projected, an area determination result, and active-method three-dimensional information may be stored on the storage unit 35. In this case, the three-dimensional information acquisition unit 42 can acquire passive-method three-dimensional information by offline processing. Further, even in a case where active-method three-dimensional information is acquired in real time by measuring a distance on the basis of a flight time elapsed before reflected light returns and passive-method three-dimensional information is acquired by offline processing, it is possible to integrate the passive-method three-dimensional information acquired by the offline processing with the active-method three-dimensional information acquired in real time and output the integrated information.

Further, the information output unit 52 may output a captured image generated in the image capturing unit 21 together with active-method three-dimensional information and passive-method three-dimensional information or integrated three-dimensional information corresponding to this captured image. As described above, when the captured image is output together with the three-dimensional information, it is possible to easily grasp a relationship between a subject in the captured image and the three-dimensional information.

Furthermore, processing of the information processing device and the image capturing device is not limited to a case where the processing is performed in step order shown in the above-mentioned flowchart or a case where the processing is performed every time when a necessary image or the like is obtained as shown in the above-mentioned timing chart. Further, acquisition of three-dimensional information using the passive method is not limited to a case where acquisition of three-dimensional information is performed in parallel to capturing of images as described above and may be collectively performed after capturing of images is terminated. In a case where acquisition of three-dimensional information using the passive method and capturing of images are performed in parallel, unnecessary captured images and area determination results can be sequentially deleted, and therefore it is possible to reduce a storage capacity of the storage unit. Further, in a case where acquisition of three-dimensional information using the passive method is collectively performed after capturing of images is terminated, all captured images used to acquire three-dimensional information by using the passive method are stored together with area determination results. Further, in a case where active-method three-dimensional information and passive-method three-dimensional information are integrated, the active-method three-dimensional information is stored together with an area determination result and the like.

Further, in a case where images of a subject are captured from different directions by moving the image capturing unit and the projection unit, the information processing device may instruct a user to move, to project a predetermined luminous flux, to capture an image, or the like or may automatically project a predetermined luminous flux and capture an image in accordance with movement. As described above, the user can easily acquire accurate three-dimensional information.

A series of processing described in the specification can be executed by hardware, software, or a combined configuration thereof. In a case of executing processing using software, a program in which a processing sequence is recorded is installed and executed in a memory in a computer included in dedicated hardware. Alternatively, it is possible to install and execute a program in a general-purpose computer capable of executing various kinds of processing.

For example, the program can previously be recorded in a hard disk drive, SSD (Solid State Drive), or ROM (Read Only Memory) as a recording medium. Or the program can temporarily or permanently be stored (recorded) in a removable medium such as a flexible disk, CD-ROM (Compact Disc Read Only Memory), MO (Magneto optical) disk, DVD (Digital Versatile Disc), BD (Blu-Ray Disc (registered trademark)), magnetic disk, semiconductor memory card. Such a removable recording medium can be provided as so-called packaged software.

Moreover, the program not only be installed in the computer form the removable recording medium but also may be installed by wireless or wired transferring into the computer via a network such as a LAN (Local Area Network) and the Internet from download sites. The computer can undergo installation of the received program, which is transferred like that, into the recording medium such as the mounted hard disk drive.

Note that the effects described in the present specification are merely examples, and not limitative; additional effects that are not described may be exhibited. It should be understood by those skilled in the art that various modifications, combinations, sub-combinations and alterations may occur depending on design requirements and other factors insofar as they are within the scope of the appended claims or the equivalents thereof.

Additionally, the information processing device according to the present technology may also be configured as below.

(1)

An information processing device including:

an area determination unit configured to determine an active-method application area in which three-dimensional information is acquired on the basis of reflected light of a projected predetermined luminous flux and a passive-method application area that is another area; and

a three-dimensional information acquisition unit configured to, on the basis of an area determination result obtained by the area determination unit, acquire the three-dimensional information by using the reflected light in the active-method application area and acquire three-dimensional information on the basis of a plurality of captured images of different viewpoints in the passive-method application area.

(2)

The information processing device according to (1),

in which the area determination unit determines a subject area in the captured images, the subject area being an area in which the reflected light is obtained, as the active-method application area.

(3)

The information processing device according to (2),

in which the area determination unit determines the active-method application area on the basis of a difference image of a captured image captured by projecting the predetermined luminous flux and a captured image captured without projecting the predetermined luminous flux, the captured images being captured in a state in which image capturing directions and angles of view are the same.

(4)

The information processing device according to any of (1) to (3),

in which the area determination unit obtains a boundary of a subject on the basis of luminance distribution of a captured image captured by projecting a luminous flux for area determination and determines a subject area in which luminance of the subject has a higher level than a predetermined level as the active-method application area.

(5)

The information processing device according to any of (1) to (3),

in which the area determination unit determines an area in the captured images, the area being an area in which a texture exists, as the passive-method application area.

(6)

The information processing device according to any of (1) to (5),

in which the three-dimensional information acquisition unit acquires three-dimensional information on the basis of the plurality of captured images of the different viewpoints also in the active-method application area, obtains a scale ratio of the three-dimensional information acquired on the basis of the plurality of captured images of the different viewpoints in the active-method application area to the three-dimensional information acquired by using the reflected light, and performs scale adjustment on the basis of the scale ratio so that a scale of the three-dimensional information of the passive-method application area acquired on the basis of the plurality of captured images of the different viewpoints matches a scale of the three-dimensional information of the active-method application area acquired by using the reflected light.

(7)

The information processing device according to (6), further including:

an information integration unit configured to perform integration of pieces of three-dimensional information so that, in the active-method application area, the three-dimensional information acquired by using the reflected light is indicated and, in the passive-method application area, the three-dimensional information that has been acquired on the basis of the plurality of captured images of the different viewpoints and has been subjected to the scale adjustment is indicated.

(8)

The information processing device according to any of (1) to (7),

in which the predetermined luminous flux is structured light.

(9)

The information processing device according to any of (1) to (7),

in which the predetermined luminous flux is projected light for measuring a distance on the basis of a flight time elapsed before reflected light returns.

Further, the image capturing device according to the present technology may also be configured as below.

(1)

An image capturing device including:

an image capturing unit configured to generate a captured image;

a control unit configured to control the image capturing unit so that the image capturing unit generates the captured image in a state in which a predetermined luminous flux is projected and generates the captured image in a state in which the predetermined luminous flux is not projected;

an area determination unit configured to determine an active-method application area in which three-dimensional information is acquired on the basis of reflected light of the projected predetermined luminous flux and a passive-method application area that is another area; and

a three-dimensional information acquisition unit configured to, on the basis of an area determination result obtained by the area determination unit, acquire the three-dimensional information by using the reflected light in the active-method application area and acquire three-dimensional information on the basis of a plurality of captured images of different viewpoints in the passive-method application area.

(2)

The image capturing device according to (1),

in which the area determination unit determines the active-method application area and the passive-method application area in accordance with brightness at the time of capturing an image.

(3)

The image capturing device according to (1) or (2),

in which the area determination unit determines the active-method application area and the passive-method application area in accordance with an image capturing mode.

(4)

The image capturing device according to any of (1) to (3),

in which the area determination unit determines the active-method application area and the passive-method application area in accordance with an image signal of the captured image.

(5)

The image capturing device according to any of (1) to (4), including:

a storage unit configured to store the plurality of captured images of the different viewpoints and the area determination result.

(6)

The image capturing device according to (5),

in which the storage unit stores the three-dimensional information acquired by using the reflected light.

(7)

The image capturing device according to any of (1) to (6), further including:

a projection unit configured to project the predetermined luminous flux,

in which the control unit controls projection of the predetermined luminous flux from the projection unit.

### INDUSTRIAL APPLICABILITY

In an information processing device, an information processing method, a program, and an image capturing device in this technology, an active-method application area in which three-dimensional information is acquired on the basis of reflected light of a projected predetermined luminous flux and a passive-method application area that is the other area are determined. Further, on the basis of an area determination result, the three-dimensional information is acquired by using the reflected light in the active-method application area, and three-dimensional information is acquired on the basis of a plurality of captured images of different viewpoints in the passive-method application area. Therefore, it is possible to acquire three-dimensional information of a subject easily, speedily, and accurately. Therefore, this technology can be used for, for example, a case where a subject is three-dimensionally displayed, a case where a subject is three-dimensionally reproduced by using a 3D printer, a case where an image is generated by changing an illumination direction to a different direction in consideration of a three-dimensional shape of a subject, and a case where an image combined with another subject is generated.

### REFERENCE SIGNS LIST

11 information processing device

12 image capturing device

21 image capturing unit

22 camera signal processing unit

23 projection unit

24 projection control unit

25 image capturing control unit

31, 32 area determination unit

35 storage unit

41, 42 three-dimensional information acquisition unit

52 information output unit

321 difference image generation unit

322 determination processing unit

411, 421 active-method three-dimensional information acquisition unit

412, 422 passive-method three-dimensional information acquisition unit

423 scaler unit

1. An information processing device comprising:
an area determination unit configured to determine an active-method application area in which three-dimensional information is acquired on the basis of reflected light of a projected predetermined luminous flux and a passive-method application area that is another area; and
a three-dimensional information acquisition unit configured to, on the basis of an area determination result obtained by the area determination unit, acquire the three-dimensional information by using the reflected light in the active-method application area and acquire three-dimensional information on the basis of a plurality of captured images of different viewpoints in the passive-method application area.

2. The information processing device according to claim 1,
wherein the area determination unit determines a subject area in the captured images, the subject area being an area in which the reflected light is obtained, as the active-method application area.

3. The information processing device according to claim 2,
wherein the area determination unit determines the active-method application area on the basis of a difference image of a captured image captured by projecting the predetermined luminous flux and a captured image captured without projecting the predetermined luminous flux, the captured images being captured in a state in which image capturing directions and angles of view are the same.

4. The information processing device according to claim 1,
wherein the area determination unit obtains a boundary of a subject on the basis of luminance distribution of a captured image captured by projecting a luminous flux for area determination and determines a subject area in which luminance of the subject has a higher level than a predetermined level as the active-method application area.

5. The information processing device according to claim 1,
wherein the area determination unit determines an area in the captured images, the area being an area in which a texture exists, as the passive-method application area.

6. The information processing device according to claim 1,
wherein the three-dimensional information acquisition unit acquires three-dimensional information on the basis of the plurality of captured images of the different viewpoints also in the active-method application area, obtains a scale ratio of the three-dimensional information acquired on the basis of the plurality of captured images of the different viewpoints in the active-method application area to the three-dimensional information acquired by using the reflected light, and performs scale adjustment on the basis of the scale ratio so that a scale of the three-dimensional information of the passive-method application area acquired on the basis of the plurality of captured images of the different viewpoints matches a scale of the three-dimensional information of the active-method application area acquired by using the reflected light.

7. The information processing device according to claim 6, further comprising:
an information integration unit configured to perform integration of pieces of three-dimensional information by using, in the active-method application area, the three-dimensional information acquired by using the reflected light and by using, in the passive-method application area, the three-dimensional information that has been acquired on the basis of the plurality of captured images of the different viewpoints and has been subjected to the scale adjustment.

8. The information processing device according to claim 1,
wherein the predetermined luminous flux is structured light.

9. The information processing device according to claim 1,
wherein the predetermined luminous flux is projected light for measuring a distance on the basis of a flight time elapsed before reflected light returns.

10. An information processing method comprising:
a step of determining, by an area determination unit, an active-method application area in which three-dimensional information is acquired on the basis of reflected light of a projected predetermined luminous flux and a passive-method application area that is another area; and
a step of acquiring, by a three-dimensional information acquisition unit, on the basis of an area determination result obtained by the area determination unit, the three-dimensional information by using the reflected light in the active-method application area and acquiring three-dimensional information on the basis of a plurality of captured images of different viewpoints in the passive-method application area.

11. A program for causing a computer to execute processing in which a captured image acquires three-dimensional information of a subject area, the program causing the computer to execute
a procedure of determining an active-method application area in which three-dimensional information is acquired on the basis of reflected light of a projected predetermined luminous flux and a passive-method application area that is another area, and
a procedure of acquiring, on the basis of on a determination result of the active-method application area and the passive-method application area, the three-dimensional information by using the reflected light in the active-method application area and acquiring three-dimensional information on the basis of a plurality of captured images of different viewpoints in the passive-method application area.

12. An image capturing device comprising:
an image capturing unit configured to generate a captured image;
a control unit configured to control the image capturing unit so that the image capturing unit generates the captured image in a state in which a predetermined luminous flux is projected and generates the captured image in a state in which the predetermined luminous flux is not projected;
an area determination unit configured to determine an active-method application area in which three-dimensional information is acquired on the basis of reflected light of the projected predetermined luminous flux and a passive-method application area that is another area; and
a three-dimensional information acquisition unit configured to, on the basis of an area determination result obtained by the area determination unit, acquire the three-dimensional information by using the reflected light in the active-method application area and acquire three-dimensional information on the basis of a plurality of captured images of different viewpoints in the passive-method application area.

13. The image capturing device according to claim 12,
wherein the area determination unit determines the active-method application area and the passive-method application area in accordance with brightness at the time of capturing an image.

14. The image capturing device according to claim 12,
wherein the area determination unit determines the active-method application area and the passive-method application area in accordance with an image capturing mode.

15. The image capturing device according to claim 12,
wherein the area determination unit determines the active-method application area and the passive-method application area in accordance with an image signal of the captured image.

16. The image capturing device according to claim 12, comprising:
a storage unit configured to store the plurality of captured images of the different viewpoints and the area determination result.

17. The image capturing device according to claim 16,
wherein the storage unit stores the three-dimensional information acquired by using the reflected light.

18. The image capturing device according to claim 12, further comprising:
a projection unit configured to project the predetermined luminous flux,
wherein the control unit controls projection of the predetermined luminous flux from the projection unit.
